(19) United States
(12) Patent Application Publication
(10) Pub. No.: US 2003/0113094 A1
(43) Pub. Date: Jun. 19, 2003

(54) Selectable video advertising display system

(76) Inventor: Bart C. Tewksbury, Laceyville, PA (US)

Correspondence Address: Sanford J. Piltch, Esq., Suite 207, 1132 Hamilton Street, Allentown, PA, 18101-1024, US

(21) Appl. No.: 10/021,859

(22) Filed: Dec. 13, 2001

(51) Int. Cl. H04N 5/76; H04N 5/781

(52) U.S. Cl. 386/46; 386/125

(57) ABSTRACT

The present invention is an audiovisual advertising and informational data playback system comprising a display monitor, or a plurality of such monitors, to display pre-selected video images which originate from a video playback apparatus such as a VCR or DVD player, optionally with sound, to a group of consumers. The advertisements presented on the display monitors may be sequentially organized as play lists predetermined by the user with the playback continuing for so long as a video playback controller continues to sense the presence of viewers proximate to the display monitors, or for a preset time, or for the length of the program.

### FIELD OF THE INVENTION

The present invention resides generally in the field of electronic data communication in the form of advertising video and accompanying text and audio displayed to a group of consumers. This apparatus may be specifically described as one or more display screens, used to play either a sequential or randomly selectable video play listing, which may be produced using a videocassette player, DVD, or some other electronic storage media.

### BACKGROUND OF THE INVENTION

The utility in the present invention is based upon the advantage of point of purchase promotion above commercial network television and radio. Television commercials are presently directed towards a mass-market general audience, while point of purchase promotion targets specific consumer groups within the general public. This is achieved by advertising in stores, ticket counters, and other venues where consumers are actively seeking information about purchasing goods. Point of purchase promotion is therefore a great money saver for advertisers, when compared with the vast amount of advertising dollars wasted on uninterested network television viewers. An example of point of purchase advertising, which is familiar to many, are popcorn, candy, and soft drink promotions that are shown in a movie theatre, prior to the feature presentation. Another example of this method of advertising is when restaurants in malls distribute free samples of their food in order to entice customers to purchase their goods.

A comparative look at the present invention in light of other subject related patents will set it apart from other inventions in the associated field. U.S. Pat. No. 5,412,416 discloses a system of transmission of advertisements in full motion video program form from a distribution center to receiving sites such as retail stores transmitted via antenna systems using a satellite. Another, U.S. Pat. No. 5,761,601 discloses a system for distributing, using a satellite, full motion videos in the form of advertisements to a plurality of businesses arrayed over a regional geographical area. The present invention differs from the inventions disclosed in these patents by the fact that the transmission of advertisements with the present invention is from a local source to a local audience. The advantage in transmitting from a local source is that the manager of the store in which the apparatus is housed may decide which video selections are played and in a desired sequence. In this manner, store and local region-specific forms of advertisement may both be provided at the manager's discretion.

U.S. Pat. No. 5,740,549 discloses an information and advertising distribution system using a data server, which stores and updates a database of information and advertisements. The modifying of information and advertisements occurs over a communications link to a distant viewing screen, such as advertisements received via internet communication over a global computer network providing advertising headers and such, to a multitude of websites accessed by the general public. Again, the invention that this patent discloses contrasts with the present invention due to the localization of data stored for display with the present invention.

### SUMMARY OF THE INVENTION

The present invention can be described as an advertising information playback system using a monitor, or a series of monitors, to display pre-selected video images, optionally with sound, to a group of consumers. The display apparatus includes a local VCR, DVD player, or comparable image displaying device connected to the video monitor or monitors, for providing changing and/or fixed video images which are set with a program sequence initiated by a local controller. Enhancement of this system may be accomplished by providing access to a larger data network for downloading information related to the geographic region in which the system is housed, for example. These monitors, which provide advertising for viewing by the general public, may be positioned at checkout counters, transportation system centers, check-in counters and waiting areas, ticketing entrances for sporting events, commuter stations for light rail, etc.

The invention may be further described as a video advertising display system comprising one or more display monitors used to present audiovisual advertising images; one or more video devices which can playback stored audiovisual advertising and informational data; one or more control means for initiating playback of the stored audio-visual advertising and informational data; and a video playback controller connected to the one or more control means for initiating playback and to the one or more video devices to initiate a control signal to begin the playback sequence by the one or more video devices of the stored audio-visual advertising and informational data.

The one or more control means for intiating playback may be one or more motion detectors which sense the presence of a viewer in proximity to the video display device(s). If motion detectors are utilized, the video play back conntroller, upon the sensing of a viewer by said one or more motion detectors, will continue the playback for so long as a viewer is sensed to be proximate the one or more video display monitors.

Alternatively, the one or more control means for initiating playback may be a control switch manually actuated by a user to initiate a control signal to begin the playback sequence by the one or more video devices of the stored audio-visual advertising and informational data. The video advertising display system may also be comprised of one or more audio speakers to provide audio corresponding to the visual advertisements presented on the one or more display monitors.

The one or more motion detectors may include an invisible light beam producer and sensor in line with a reflective mirror, which sensor will detect a disturbance in the reflection of the light beam when a viewer passes through the light beam. The video device may be either a videotape player or a DVD player.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a perspective view of the selectable video advertising display apparatus mounted adjacent to a supermarket checkout aisle.

FIG. 2 is a perspective view of the present invention mounted adjacent to and viewable from multiple checkout aisles. FIG. 3 is a perspective view of a plurality of selectable video advertising display apparatus mounted adjacent pre-selected groups of checkout aisles at supermarkets having a single master control.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

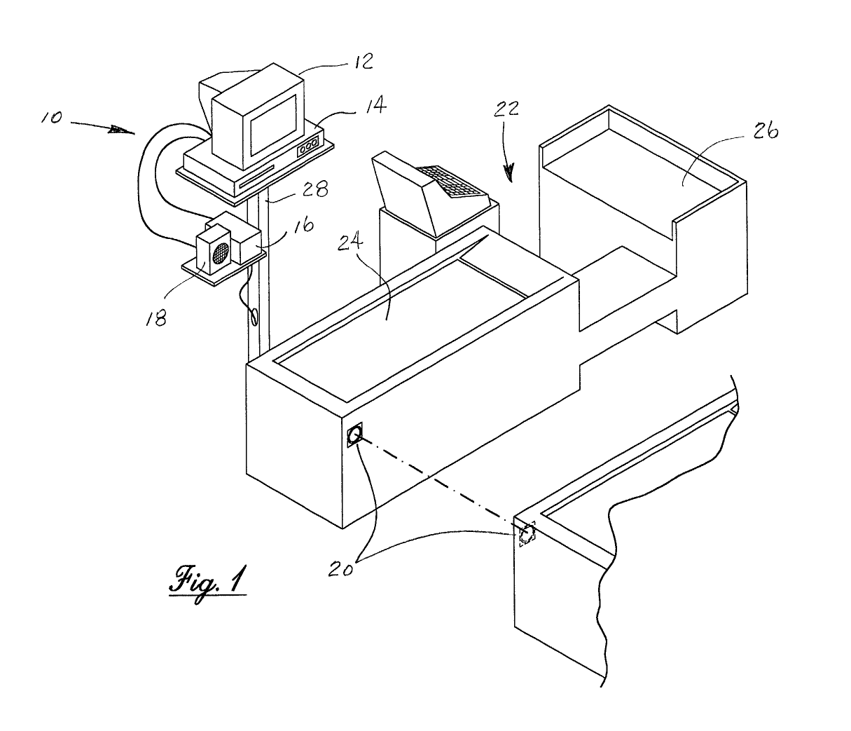

Referring now to the drawings in detail, where like numerals refer to like parts or elements, there is shown in FIG. 1 a video advertising display system 10 set up adjacent to a checkout counter 22, complete with conveyer belt 24 and packing station 26, located in a retail store. Raised above the checkout counter 22 and positioned upon a stand 28, the video display monitor 12 may be mounted atop a video playback apparatus 14, such as a DVD player or videotape player, which converts pre-recorded advertising information and transmits the information in the form of recognizable images to the display monitor 12. A separate audio speaker 18 receives audible information stored on the pre-recorded video disk or videotape and provides corresponding and simultaneous soundtrack for the visual advertisements displayed on the monitor 12.

The pre-recorded information which may be placed on a videotape is placed on the tape in a desired playback sequence. The sequence may have one or more audiovisual advertisements which are repeated, mixed with single occurrence audiovisual advertisements as the tape plays. Further, one videotape may contain audiovisual advertisements which are keyed to a specific group of related goods available for sale in the retail store for a limited period of time, or contain audiovisual advertisements which are keyed to goods and services available in the local area, or contain a mixture of both. In the case where the video playback apparatus 14 is a DVD player, the user may program the order or sequence of the audiovisual advertisements in any desired order selecting certain advertisements for repeat display as desired. Although the video playback apparatus 14 is shown located immediately adjacent to the video display monitor 12, the video playback apparatus 14 may be located below the checkout counter 22 or be located at a more secure, but distant point, in the store to provide both ease of access to exchange videotapes (or program the apparatus) without the need to close the checkout line.

The video advertising display system 10 does not remain playing continuously if there are no prospective viewers in the checkout line. The video advertising display system 10 can be started when a consumer passes the motion sensor 20, which is located at the entrance to the checkout aisle. The motion sensor 20 provides an invisible light beam, e.g. infra-red, across the aisle which is reflected back to a sensor by a mirror positioned directly in-line with the light beam. The motion sensor 20 is capable of detecting a disturbance in the beam of light when a customer walks into the aisle or when a customer pushes a cart into the aisle. The detection of the disturbance in the light beam causes a change in state in the video playback controller 16 with a resulting control signal triggering the start of the advertising playback sequence. The controller 16 will continue the playback control signal to the video playback apparatus 14 until a preset time delay has been reached indicating that there have been no further disturbances to the light beam (no consumers or carts interrupting the light beam) at which time the control signal will stop the playback since it may be reasonably assumed that there are no viewers in position to watch and hear the audiovisual advertisements.

Alternatively, the controller 16 may be initiated by a manual control signal from the store manager or other employee by engaging either a Start/Play control switch on the controller 16 or by receiving a comand signal from an associated computer. The Start/Play control switch functions to begin play of the desired sequence of informational data such as advertisements, informational commercials, and local/regional calendar events including, but not limited to, sports, theatre and local/regional events of historical or religious significance. The controller 16 will continue the playback control signal to the video playback apparatus 14 until a preset time delay has been reached, or the video sequence has ended.

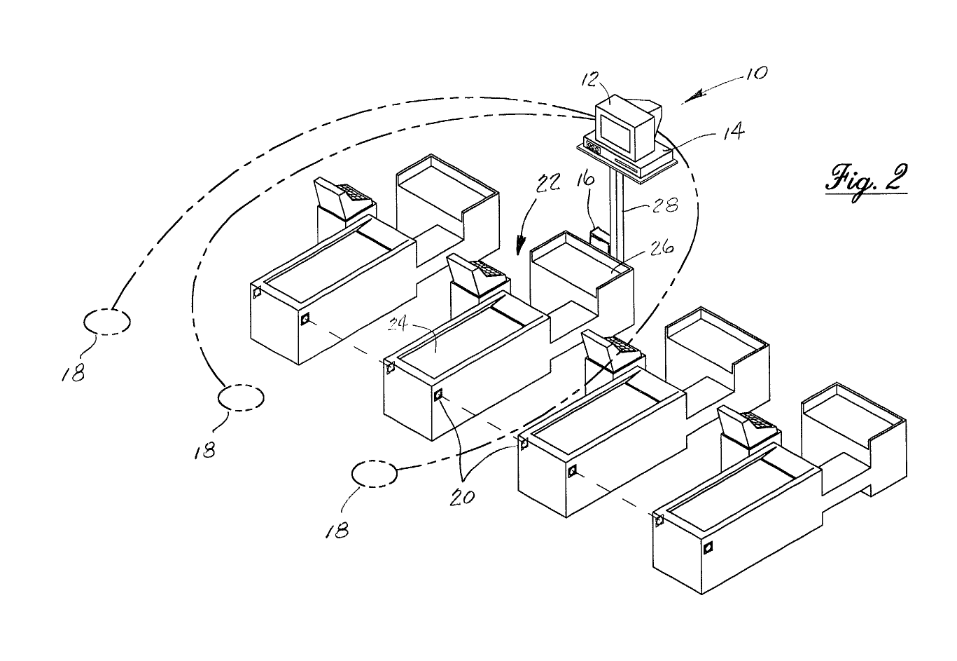

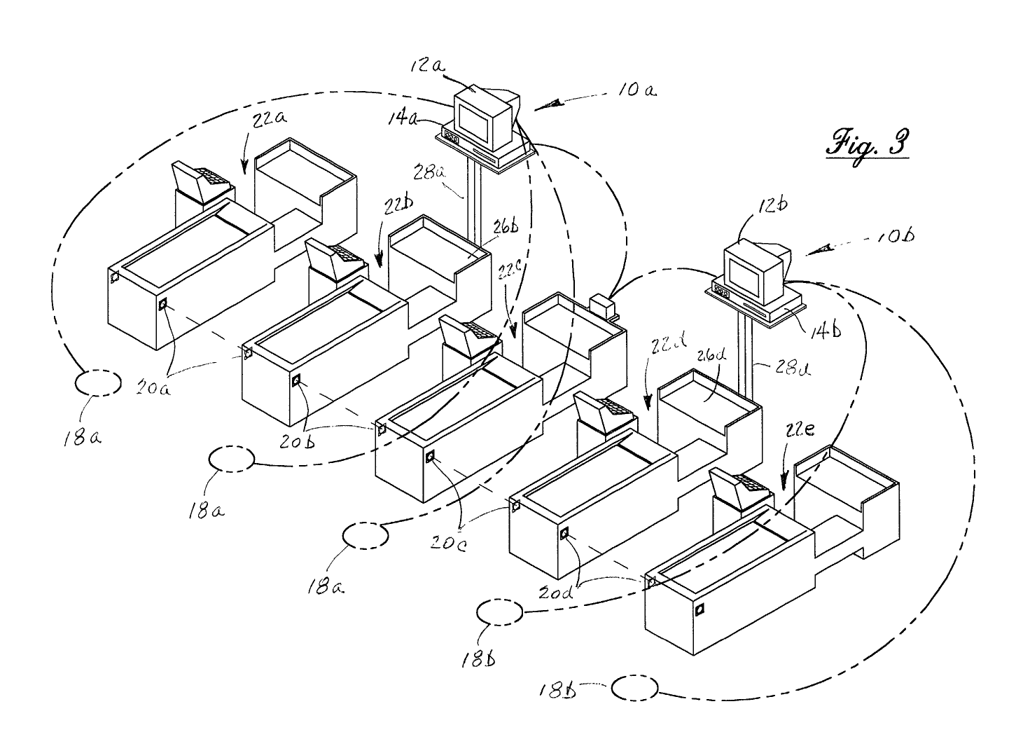

FIG. 2 shows a slightly different arrangement of the present invention in which the video display monitor 12 and video playback apparatus 14 are raised by a stand 28 located behind the packing station 26 of one of the checkout counters 22 which may be viewed from different vantage points within its immediate vicinity, namely across three checkout aisles. Speakers 18 are placed above the entrances to the checkout aisles in order that the consumers may see the audiovisual advertisements from the distant display monitor 12 while hearing the audio from the local speakers 18. The speakers 18 may be positioned at closer or more distant points, or both, depending upon the coverage area desired for the store or other venue.

As in the case of the single checkout aisle, the video advertising display system 10 does not remain playing continuously if there are no prospective viewers in the checkout aisles. The video advertising display system 10 will be started when a consumer passes any of the motion sensors 20, which are located at the entrances to each of the checkout aisles. The motion sensor 20 will provide an invisible light beam, e.g. infra-red, across each aisle which is reflected back to a sensor by a mirror positioned directly in-line with the light beam. The motion sensors 20, as described above, are capable of detecting a disturbance in the beam of light when a customer walks into any aisle or when a customer pushes a cart into the aisle. The detection of a disturbance in any of the light beams of the motion sensors 20 causes a change in state in the video playback controller 16 with a resulting control signal triggering the start of the advertising playback sequence regardless of the aisle in which the light beam interruption was detected. The controller 16 will continue the playback control signal to the video playback apparatus 14 until a preset time delay has been reached indicating that there have been no further disturbances to any of the light beams (no consumers or carts interrupting the light beams) at which time the control signal will stop the playback since it may be reasonably assumed that there are no viewers in position to watch and hear the audiovisual advertisements.

FIG. 3 depicts yet another arrangement of the present invention consisting of two video advertising display systems 10a, 10b located in a retail store which houses multiple checkout counters 22a, 22b, 22c, 22d, and 22e. Video advertising display system 10a includes video display monitor 12a and video playback apparatus 14a which are mounted atop stand 28a located behind packing station 26b. Video advertising display system 10b includes display monitor 12b and video playback apparatus 14b which are mounted atop stand 28d located behind packing station 26d. Each of the checkout aisles is equipped with motion sensors 20a, 20b, 20c, 20d which operate in the identical manner as the motion sensors described above with reference to FIGS. 1, 2. Once a customer passes through one of these checkout aisles, the corresponding motion sensor for that aisle sends a signal to the video playback controller 16 triggering the start of the advertising sequence. However, with plural monitors 12a, 12b the detection of a disturbance in the light beam in the aisles next to checkout counters 22a and 22b will cause the start of the playback of the audiovisual advertisements in monitor 12a from video playback apparatus 14a. Speakers 18a, which are positioned at the entrances to checkout aisles 22a, 22b, will begin sounding the audio portion of the audiovisual advertisements playing on the display monitor 12a. If a disturbance in the light beam is detected in aisles next to checkout counters 22c or 22d, playback of the audiovisual advertisements will start on display monitor 12b from video playback apparatus 14b. Similarly, speakers 18b, which are positioned at the entrances to aisles 22c, 22d, will begin sounding the audio portion of the audiovisual advertisements playing on the display monitor 14b. Each of the display monitors 12a, 12b will continued playback of the audiovisual advertisements until such time as no further disturbances are detected in any of the checkout aisles as monitored by the video playback controller 16 through the several motion sensors 20a-d.

As in the arrangements described above, the controller 16 will continue the playback control signal to either of the video playback apparatus 14a, 14b until a preset time delay has been reached indicating that there have been no further disturbances to any of the light beams (no consumers or carts interrupting the light beams) associated with that video playback apparatus at which time the control signal will stop the playback since it may be reasonably assumed that there are no viewers in position to watch and hear the audiovisual advertisements. Thus, if there are no further disturbances or interruptions in the light beams across the aisles next to checkout counters 22a, 22b, the playback of the audiovisual advertisements through the video playback apparatus 14a, video display monitor 12a and speakers 18a will be curtailed. The same will occur in the event that there are no further disturbances or interruptions in the light beams across the aisles next to checkout counters 22a, 22b. The playback of the audiovisual advertisements through the video playback apparatus 14b, video display monitor 12b and speakers 18b will be curtailed.

There are other venues within a retail store setting, other than the checkout aisles in which the present invention may be utilized. At certain counters where foodstuffs need to be requested in amounts and packagings not available in pre-packaged containers, e.g. a meat, cheese or fish counter, or any place where ordering of the quantity and types of foodstuffs requires direct interaction between the customer and the employees of the store. There may also be locations within the retail store where seasonal displays will attract customers and the video display advertsising system 10 of the present invention would be useful in providing audio-visual informational data to the customers.

The arrangements described above illustrate only a limited number of ways in which the video advertising display system 10 may be set up and controlled. The following examples are intended to demonstrate additional and different capabilities for which the present invention may be used.

### EXAMPLE 1

The video advertising display system 10 may be used at one entrance to a large stadium. This particular entrance has five ticket booths and a display monitor is placed behind each booth within view of the entering event attendees. Speakers are placed above the aisles next to the ticket booths in order to provide audio to people farther back in line. A DVD player is located in one of the ticket booths and is used to program the sequence and play of the repeating playback schedule of the advertisements shown simultaneously on all five video display monitors. In this instance the local user has control over the exact order of the audio-visual advertisement which is presented on the monitors. The advertising sequence in this instance lasts for eight minutes and is set to repeat again and again. The advertisement content consists of ‘support your team by purchasing shirts, hats, pennants, etc.’ promotions, announcements of upcoming games, a spotlight on one player on the team who does charity work, and team-endorsed soft drinks.

### EXAMPLE 2

The video display advertising system 10 is set up at the checkout line of a large store specializing in musical instruments and related accessories. The user programs the order of the advertising sequence on a DVD player, which is being utilized as the video playback apparatus. The video display monitor faces the front of the checkout counter and an audio speaker is positioned on the counter. A light beam sensor located in front of the checkout counter detects the presence of a customer triggering the playback of the audiovisual advertisements to begin. This advertising sequence is five minutes in length and consists of an announcement of a store sale in the near future, a commercial for an amplifier brand endorsed by a famous musician, promotion of an upcoming music festival, and a display of the craftsmanship behind the making of a certain brand of acoustic guitar. The store manager likes to modify the advertising sequence approximately once a week which is facilitated by the use of a DVD player rather than a videotape player, which can only play the audiovisual information placed on the videotape in sequence.

### EXAMPLE 3

A supermarket owner sets up the video advertising display system 10 in a similar fashion as that shown in FIG. 3. The sequenced program consists of five different audiovisual advertisements, each of which are displayed in a random or shuffle fashion, however none are shown back to back. Certain ones of the audio-visual advertisements are for food items of which the store has an overstocked inventory and others are for promotions of foodstuff manufacturers and distributors. The ability to selectably program the audio-visual advertisement is one benefit and advantage of being able to program the advertising sequence locally rather than obtain pre-programmed audio-visual advertisements which must be played in the sequence received.

It is to be understood that the components of the video advertising display system 10 may be positioned as described, or may be positioned in other like circumstances without departing from the teachings of the present invention. As described above, the video playback apparatus 14 need not be positioned immediately adjacent the video display monitor 12, but can be placed in a more secure location such as the store office or a utility closet for the more public venues such as commuter stations and stadiums. The motion sensors 20 may be of other types, e.g. infra-red (without beam reflective mirrors) or sound activated, and are required only to be able to detect the proximity of consumers to the video display monitor 12. Alternatively, the Start/Play control switch may be manually initiated by the user. The stand 28 may be replaced by wall or ceiling mounts for the video display monitor 12 depending upon the venue. The positioning of the audio speakers 18 is dependent upon the number of consumers desired to be reached simultaneously by the audiovisual advertisement and the size of the venue. If only a checkout aisle, the number of speakers 18 can be relatively limited, but if the venue is a commuter station with its cacophony of noise, the number of speakers 18 will be significantly increased in order that the consumer can hear the audiovisual advertisement.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A video advertising display system comprising:
one or more display monitors used to present audio-visual advertising images;
one or more video devices which can playback stored audiovisual advertising and informational data;
one or more control means for initiating playback of the stored audio-visual advertising and informational data; and
a video playback controller connected to the one or more control means for initiating playback and to the one or more video devices to initiate a control signal to begin the playback sequence by the one or more video devices of the stored audio-visual advertising and informational data.

2. The video advertising display system of claim 1 wherein said one or more control means for intiating playback being one or more motion detectors to sense the presence of a viewer.

3. The video advertising display system of claim 2 wherein said video play back conntroller, upon the sensing of a viewer by said one or more motion detectors, will continue the playback for so long as a viewer is sensed to be proximate the one or more video display monitors.

4. The video advertising display system of claim 1 wherein said one or more control means for initiating playback being a control switch manually actuated by a user to initiate a control signal to begin the playback sequence by the one or more video devices of the stored audio-visual advertising and informational data.

5. The video advertising display system of claim 1 further comprising one or more audio speakers to provide audio corresponding to the visual advertisements presented on the one or more display monitors.

6. The video advertising display system of claim 1 wherein said one or more motion detectors include an invisible light beam producer and sensor in line with a reflective mirror, which sensor will detect a disturbance in the reflection of the light beam when a viewer passes through the light beam.

7. The video advertising display system of claim 1 wherein said video device is a videotape player.

8. The video advertising display system of claim 1 wherein said video device is a DVD player.
